(19) United States
(12) Patent Application Publication
(10) Pub. No.: US 2023/0024894 A1
(43) Pub. Date: Jan. 26, 2023

(54) SYSTEM AND METHOD FOR SELECTING A CERTIFIED PUBLIC ACCOUNTANT

(71) Applicant: Halcyon Still Water, LLC, Red Bank, NJ (US)

(72) Inventors: Conway K. Donaldson, Fair Haven, NJ (US); James W. McGowan, Flemington, NJ (US); Elizabeth A. Boonin, East Setauket, NY (US)

(21) Appl. No.: 17/873,678

(22) Filed: Jul. 26, 2022

Related U.S. Application Data
(60) Provisional application No. 63/225,791, filed on Jul. 26, 2021.

(51) Int. Cl. G06Q 40/00; G06Q 50/26

(52) U.S. Cl. CPC G06Q 40/123; G06Q 50/26

(57) ABSTRACT

The system may automatically filter data according to multiple criteria. The method may be applied for the selection of a certified public accountant according to multiple criteria relevant to a particular client. The method may include receiving various criteria, requesting a plurality of target data structures, receiving various weights associated with various criteria, and then identifying which of the target data structures reflect greater or lesser correspondence to the criteria in view of the criteria weighting. The method may filter target data structures to reject target data structures lacking sufficient correspondence to the criteria and may transmit the remaining data structures to a remote selection device.

### CROSS-REFERENCE TO RELATED APPLICATIONS

This disclosure claims priority to, and the benefits of, U.S. Ser. No. 63/225,791 filed on Jul. 26, 2021, and entitled “SYSTEM AND METHOD FOR SELECTING A CERTIFIED PUBLIC ACCOUNTANT,” which is hereby incorporated by reference in its entirety for all purposes.

### TECHNICAL FIELD

This disclosure generally relates to automatically filtering data according to criteria, and more particularly, to a system and method for automatically filtering data according to criteria to automate the selection of a certified public accountant.

### BACKGROUND

Certified Public Accountants typically have different skills, different jurisdictionally limited licenses, and different models and processes for client engagement. However, data relating to the characteristics of different certified public accountants is often unstructured and lacks consistency. As such, existing computer systems for automatic selection of a certified public accountant or matching of a certified public accountant to a client requires significant human intervention. Correspondingly, traditional machine methods for automatically filtering data according to criteria are often not accurate and usually return undesirable results. Thus, there remains a need for an automated system and method for selecting a certified public accountant by filtering data according to criteria and performs with accuracy and precision.

### SUMMARY

The system may automatically filter data according to multiple criteria. In various embodiments, the method may include receiving, by a scoring computer, a first mandatory selection criteria corresponding to a first user selection. The method may include receiving, by the scoring computer, at least one preferred criteria comprising a criterion and a weight corresponding to a second user selection. The method may include requesting, by the scoring computer, at least a plurality of target data structures comprising a target identifier and plurality of target criteria from a target data repository. The method may include filtering, by the scoring computer, the target data structures to reject target data structures lacking a target criterion from among the plurality of target criteria that corresponds to the first mandatory selection criteria, to generate a first remaining target data structure set. The method may include filtering, by the scoring computer, the target data structures to reject target data structures further lacking the target criterion corresponding to at least one preferred criteria to generate a final target data structure set. Finally, the method may include transmitting, by the scoring computer, the final target data structure set to a remote selection device via a network.

In various embodiments, the method may also include receiving by the remote selection device, the final target data structure set. The method may include ranking, by the remote selection device, the target data structures according to a greatest to a least of the weight associated with the criteria. The method may include displaying an ordered list corresponding to the ranking of the target data structures on a user interface of the remote selection device.

In various embodiments, the method contemplates receiving by the remote selection device, the final target data structure set. The method may include ranking, by the remote selection device, the target data structures according to a greatest to a least of a sum of weights associated with a plurality of criteria for each target data structure. The method may also include displaying an ordered list corresponding to the ranking of the target data structures.

In various embodiments, the first mandatory selection criteria is received from the remote selection device, wherein the remote selection device is configured to receive the first user selection via a user interface and transmit the first user selection over the network and to the scoring computer. Moreover, in various embodiments, the first mandatory selection criteria is a selection of a jurisdiction in which tax services are needed, and the target data structures each correspond to a certified public accountant providing tax services. The target criterion may be an active license in a jurisdiction corresponding to the first mandatory selection criteria. The preferred criteria may be selected from a group including a specific expertise related to tax services, a practice specialization that would be required based upon a tax returns, the software a certified public accountant employs to complete the tax returns, a physical location of the certified public accountant, an availability of the certified public accountant to work remotely, and a criteria that would be useful in determining a fitness of the certified public accountant against a need of a client. The target criteria may include (a) percentage of filing business dedicated to a specialty, (b) years of experience in a specialty, and (c) physical distance from a filer.

The weight associated with the criteria may be a value between 0 and 1 inclusive, that sum to 1 for all criteria associated with the target identifier. The displaying the ordered list may include displaying a single target data structure corresponding to the greatest of the weight associated with the criteria.

### BRIEF DESCRIPTION OF THE DRAWINGS

The accompanying drawings, wherein like numerals depict like elements, illustrate exemplary embodiments of the present disclosure, and together with the description, serve to explain the principles of the disclosure. In the drawings:

FIG. 1 shows a system for the automatic filtering of data according to multiple criteria, in accordance with various embodiments; and

FIGS. 2A-B illustrate a flowchart of an exemplary method for the automatic filtering of data according to multiple criteria, in accordance with various embodiments.

### DETAILED DESCRIPTION

A system and method may automatically pair a tax client (“client”) with a Certified Public Accountant (CPA) from a candidate set of CPAs, that optimizes several characteristics. A tax client may include, for example, a computer, person, company or organization in need of tax services. Further, the system and method can be used to list, rank, or order the CPAs, allowing the client to apply or input additional criteria (e.g., associated with the client), or a different weighting to existing criteria.

Criteria may include classes such as, for example “mandatory” and “preferred.” Mandatory criteria may include, for example, an active license in the selected tax jurisdiction. Preferred criteria may include, for example, expertise in the practice area, such as non-profit or LLC. This process may be useful in helping a client find a CPA in an automated fashion and would be useful in large-scale applications. Moreover, while pairing of a client and CPA is an example use case discussed at length in this disclosure, one may appreciate that other use cases are contemplated such as pairing any type of client or entity with any type of other person or other entity.

Generally, existing computer systems for automatic selection, ranking and/or matching of structured data with relatively free form or unstructured input requirements are limited by a need for significant human intervention during the data matching process. As such, traditional machine methods for automatically filtering data according to criteria often do not adequately perform, causing automated methods to return undesirable results because current machine solutions to the problem of automatically filtering data according to criteria exhibit limited performance. The system and method herein may provide for a machine solution to this machine problem by providing a method of automatically filtering data according to criteria but without exhibiting the aforementioned performance limitations associated with poor ranking or poor matching behaviors, nor a need for human intervention or interruption of the machine matching process. As such, the method solves a machine problem of structuring highly unstructured and free form data, matching various data, and returning meaningful results that are accurate and precise.

The system allows users to access CPA data and client records, and receive updated CPA data in real time from other users. The system may store the CPA information (e.g., in a standardized format) in a plurality of storage devices, provide remote access over a network so that users may update the CPA information in a non-standardized format (e.g., dependent on the hardware and software platform used by the user) in real time through a GUI, convert the updated CPA information that was input (e.g., by a user) in a non-standardized form to the standardized format, automatically generate a message (e.g., containing the updated CPA information) whenever the updated CPA information is stored and transmit the message to the users over a computer network in real time, so that the user has immediate access to the up-to-date CPA information. The system allows remote users to share CPA information in real time in a standardized format, regardless of the format (e.g. non-standardized) that the information was input by the user. The system may also include a filtering tool that is remote from the end user and provides customizable filtering features to each end user. The filtering tool may provide customizable filtering by filtering access to the CPA information. The filtering tool may identify CPA information or accounts that communicate with the server and may associate a request for content with the individual CPA account. The system may include a filter on a local computer and a filter on a server.

The non-standardized formats may include, for example, unstructured, free-form text, key words spotted on forms (e.g., federal forms or tax filing forms) or any other format not explicitly intended to represent the CPA information. The system may convert the non-standardized formats into standardized formats. The standardized formats may include, for example, JSON, YAML, XML or other common data formats configured to explicitly list CPA information. For instance, the system could detect the word “non-profit” on a Schedule K−1 tax form and convert that to a portion of a JSON format represented as {“experience”: {“non-profit”: true}}. Also, the non-structured data may include an on-line review. For example, a client may include in a non-structured format “Worked on my non-profit” and the system may convert the non-structured format using machine learning text extraction techniques to a standardized JSON format. The system may include a database curated words for more common tax situations that may be recognized on a document by the system. Such words may include, for example, not-for-profit, non-profit, farm, C-corp, S-corp, limited liability corporation, partnership, sole proprietorship, etc.

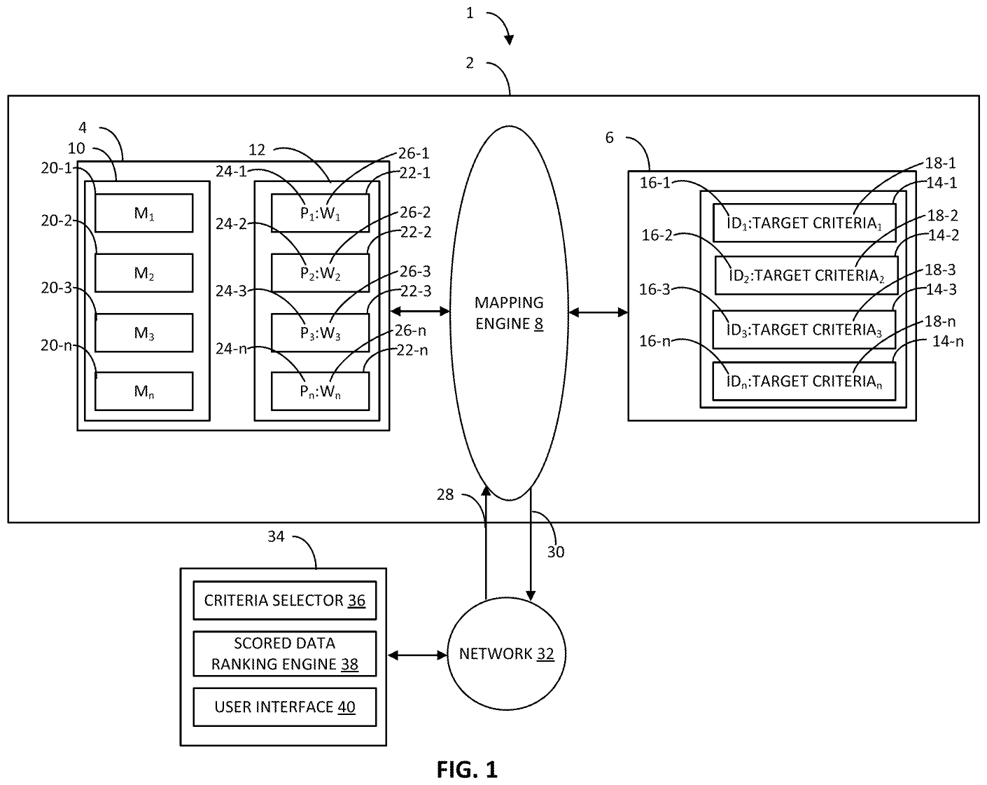

With reference to FIG. 1, a system 1 for automatically filtering data according to multiple criteria may include a scoring computer 2. The scoring computer 2 may comprise a computer, such as a processor (e.g., mapping engine 8) and a memory (e.g., target data repository 6). The scoring computer may process input data to perform calculations, make decisions, and generate outputs.

The system 1 may include a remote selection device 34. A remote selection device 34 may comprise a remotely disposed computer that facilitates a user entering instructions or data to the system 1 and which renders outputs of the system 1 in a human readable form.

The remote selection device 34 and the scoring computer 2 maybe connected via a network 32. The network 32 may comprise the internet, a local-area network, a direct connection, or other interconnection.

Turning in greater detail to the scoring computer 2, various methods may be performed by various components thereof. FIG. 1 also illustrates representations of data structures. While the data structures are shown inside the scoring computer 2, one may appreciate that data structures may be stored in separate memory, or in a distributed memory or other location as desired. For instance, the scoring computer 2 may have a master data structure 4. The master data structure 4 may comprise data corresponding to a specific user, or data entered by a specific user. The master data structure 4 may comprise a variety of fields having different values stored in the fields. For instance, the master data structure 4 may include mandatory criteria and preferred criteria. These criteria are used by a mapping engine 8 to identify different target data structures that must satisfy the mandatory criteria, and that may satisfy the preferred criteria. The system converting to a standardized format helps speed processing and searching. The system can perform a single conversion (which may be costly and time consuming) from non-structured data to structured data, then the system can much more rapidly search that structured data using tools (e.g., Structured Query Language (SQL)).

For instance, the master data structure 4 may include a mandatory criteria set 10. The mandatory criteria set 10 may include one or more criteria that must be found in a corresponding data structure of a target data set 6 by a mapping engine 8, otherwise that data structure is removed from further processing. The system may mark the criteria as mandatory through, for example, initial configuration of the data structure, or through filter criteria set by the client during processing. For instance, a mandatory criteria set 10 may include a first mandatory criterion (M₁) 20-1, a second mandatory criterion (M₂) 20-2, a third mandatory criterion (M₃) 20-3, and any number, n, of mandatory criteria such as a n-th mandatory criterion (Mₙ) 20-n.

The master data structure may include a preferred criteria set 12. The preferred criteria set may include one or more preferred criterion object that may be found in a corresponding data structure of a target data set 6 by a mapping engine 8. While mandatory criteria are—as indicated—mandatory, data structure with a preferred criterion object is not—in every case—discarded from further processing if the corresponding criteria is not found in a corresponding data structure of a target data set 6 by the mapping engine 8. A preferred criterion object includes both a preferred criterion and a weighting factor that indicates a degree of preference for a criterion between 0 (no preference) and 1 (mandatory). The mapping engine may assign a single value by combining the weights across each criterion. For instance, weights may be combined through simple summation, such that for each matching criterion, the weight is added to a total, and for each non-matching criterion 0 is added to the total. For instance, a preferred criteria set 12 may include a first preferred criterion object 22-1 having a first preferred criterion 24-1 and a first weighting 26-1. The preferred criteria set 12 may include a second preferred criterion object 22-2 having a second preferred criterion 24-2 and a second weighting 26-2. The preferred criteria set 12 may include a third preferred criterion object 22-3 having a third preferred criterion 24-3 and a third weighting 26-3. The preferred criteria set 12 may include a fourth preferred criterion object 22-4 having a fourth preferred criterion 24-3 and a fourth weighting 26-4. The preferred criteria set 12 may include any number, n, of preferred criterion objects such as a n-th preferred criterion object 22-n having a n-th preferred criterion 24-n and a n-th weighting 26-n.

As mentioned, the scoring computer may also receive target data structures which may be stored in a target data set 6. FIG. 1 illustrates a target data set 6 having a first target data structure 14-1, a second target data structure 14-2, a third target data structure 14-3, and any number ‘n’ of target data structures such as a target data structure 14-n.

A target data structure 14-1, 14-2, 14-3, 14-n may include two data fields. For instance, a target data structure may include an identifier field (ID) that includes a unique identifier of the target data structure, such as a name or a number. Specifically, a first target data structure 14-1 may include a first identifier field 16-1 (ID₁); a second target data structure 14-2 may include a second identifier field 16-2 (ID₂); a third target data structure 14-3 may include a third identifier field 16-3 (ID₃); and, any number of target data structures, such as a n-th target data structure 14-n may include a n-th identifier field 16-n (IDₙ). Similarly, a target data structure may include a target criteria field. A target criteria field may include data representative of one or more criteria of the associated identifier. For instance, the target criteria field may include particular features or skills of a person or thing having the unique identifier. In various instances, a first target data structure 14-1 may include a first target criteria field 18-1; a second target data structure 14-2 may include a second target criteria field 18-2; a third target data structure 14-3 may include a third target criteria field 18-2; and, any number of target data structures, such as a n-th target data structure 14-n may include a n-th target criteria field 18-n.

The scoring computer 2 may include a mapping engine 8. The mapping engine 8 may include one or more processor and/or memory configured to receive the master data structure 4 and/or elements thereof, as well as receive the target data set 6 and/or elements thereof, and perform calculations, make decisions, and generate outputs. Inputs may include a criteria selection input 18 and a data structure correspondence output 30, both of which may exchange data with the remote selection device 34 via the network 32. For instance, the criteria selection input 18 may receive data entered by a user into a user interface 40 of the remote selection device 34 and capture (e.g., received and/or stored) by a processor and/or memory (e.g., a criteria selector 36) of the remote selection device 34. The data structure correspondence output 30 may provide data corresponding to the identifier fields of target data structures having target criteria that satisfy the mandatory criteria and which have a rank order associated with relative degrees of satisfaction of the preferred criteria.

The discussion so far has introduced a mandatory criteria set 10 made of mandatory criteria 20-1, 20-2, 20-3, 20-n, and a preferred criteria set 12 made of preferred criterion objects 26-1, 26-2, 26-3, 26-n (each having a criterion and weighting). The discussion below provides example embodiments of the specific use cases of each. Similarly, a target data set 6 has been disclosed including target data structures 14-1, 14-2, 14-3, 14-n each having an identifier field 16-1, 16-2, 16-3, 16-n and a target criterion 14-1, 14-2, 14-3, 14-n. The discussion below provides example embodiments of the specific use cases of each. The discussion below elaborates on one non-limiting example embodiment corresponding to a machine selection of a CPA.

For example, in various instances, a mandatory criterion may be a relevant tax jurisdiction of a client. For instance, a client may use a criterion selector 36 of a remote selection device 34 to enter a criteria selection corresponding to a specific jurisdiction. In various embodiments, the mandatory criteria (or any of the other criteria or data discussed herein) may be pre-loaded or dynamically fed into the system such that the user may select certain mandatory criteria (e.g., checkbox, drop down menu, etc). The system may provide a custom list of mandatory criteria based on the user ID. The system may also allow free form entry of the mandatory criteria by the user. The remote selection device 34 may provide this data to the criteria selection input 18 of the mapping engine 8, which then stores this value in a field of the mandatory criteria set 10, such as a first mandatory criterion 20-1.

A preferred criterion may be entered in a similar way via a remote selection device 34. In various embodiments, the preferred criteria may be pre-loaded or dynamically fed into the system such that the user may select certain preferred criteria (e.g., checkbox, drop down menu, etc). The system may provide a custom list of preferred criteria based on the user ID. The system may also allow free form entry of the preferred criteria by the user. For instance, a user may enter a first preferred criterion 24-1 that is stored in a field of a first preferred criterion object 22-1, as well as entering a first weighting 26-1 for that first preferred criterion 24-1 that is stored in a field of the first preferred criterion object 22-1. A preferred criterion may include such items as the practice specialization that would be required based upon the tax returns, the software the CPA employs to complete the tax forms, the physical location of the CPA, the availability of the CPA to work remotely, and/or any other criteria that would be useful in determining the fitness of the CPA against the needs of the client. Practice specialization may include, for example, non-profit or LLC experience. The software the CPA uses may include, for example, UltraTax Thomson or TurboTax by Intuit. The physical location of the CPA may include the geographic coordinates or zip code of the CPA's place of business, or the distance from the CPA to the client. A weighting factor may be a set of weights between 0 and 1 inclusive, that sum to 1, that help weigh the importance of each factor.

In various embodiments, target data structures 14-1, 14-2, 14-3, 14-n of the target data set 6, and more specifically, identifier fields 16-1, 16-2, 16-3, 16-n may include a code, name, or other unique identifier of a CPA from an existing database of CPAs that include CPAs licensed to practice or operate in the selected jurisdiction (e.g., satisfy a mandatory criterion 20-1, 20-2, 20-3, 20-n of a mandatory criteria set 10). For example, if New Jersey is selected, the IDs for CPAs licensed to practice in New Jersey will be selected, including whether the CPAs are licensed in multiple jurisdictions. As such, the target data set 6 may be iteratively filtered, such as to only include data structures corresponding to mandatory criteria prior to subsequent filtering relative by the preferred criteria set 12. In various embodiments, the system may implement the filtering with or without creating a new DB. For instance, the system may add these mandatory criteria to a SQL SELECT, and that output could be saved in a new DB. The system may add future criteria to that same initial SQL SELECT.

Target data structures 14-1, 14-2, 14-3, 14-n of the target data set 6, and more specifically, target criteria 18-1, 18-2, 18-3, 18-n may include items such as non-profit experience, among other specializations. Target criteria 18-1, 18-2, 18-3, 18-n may include, for example, (a) percentage of filing business dedicated to each specialty, (b) years of experience in the specialty, and (c) physical distance from the filer. Referring to the earlier-mentioned preferred criteria and weighting factors, one may appreciate that the mapping engine 8 may map target criteria to preferred criterion objects and identify target criteria that match with the preferred criteria of the preferred criterion objects. The system may convert the non-structured format to a structured format to help with the matching. For example, the system may convert the non-standard formats of “5 years of experience” and “five years of experience” to a standard format of {“years of experience”: 5}. The system may then use the standard format to map target criteria to preferred criterion objects and identify target criteria that match with the preferred criteria of the preferred criterion objects. The mapping engine 8 may then use the weight to determine the relative importance of that match, and subsequently may rank the target data structures from greatest to least match based on the magnitude of the rank. For instance, if a tax filer rates percentage of business as 0.2, years of experience as 0.7, and physical distance as 0.1, then those weights are multiplied by the target criteria, and the results summed (i.e., the dot product of the target criteria and the preferred criteria) to generate a rank score. To obtain suitable data to use for the calculation, in various embodiments, the system may structure the data to a physical metric such as, for example, {“miles”: 5}. In various embodiments, the system may assign a distance score such that 0-2 miles is 1, 2-10 miles is 0.7, 10-50 miles is 0.02, and beyond 50 miles is 0.01, and then multiply that distance score by the weight.

The mapping engine 8 may use the data structure correspondence output 30 after the weighting has been calculated to transmit the value of the identifier field for each selected CPA and rank score to a remote selection device 34. The remote selection device 34 may include a computer or smartphone with a processor that performs a scored data ranking function (e.g., a scored data ranking engine 38). The scored data ranking function may sort the identifier files via rank scores, apply a selection algorithm such as to choose a single CPA, or instruct a user interface 40 to render information based upon the CPA information and score. The remote selection device 34 may be a computer with a web browser and visual display, with a web page configured to show the information on a table. The table would show a CPA and the score in each row. The selection algorithm may select a single CPA based on the highest score, or a set of CPAs in which the score exceeds a certain threshold, or all CPAs in order of score from highest to lowest.

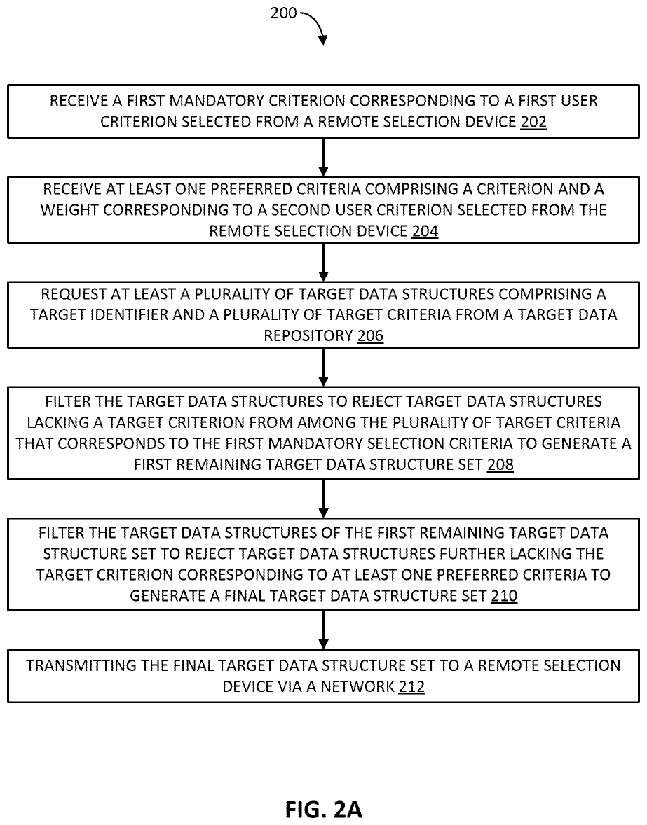

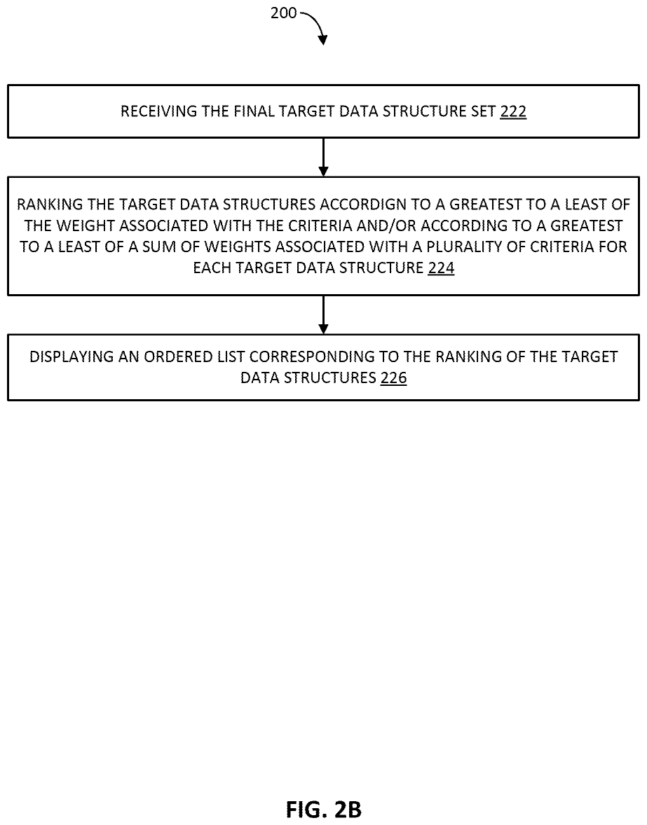

Thus, with reference now to FIGS. 2A-B, a method for automatically filtering data according to multiple criteria 200 is provided. The method may include receiving, by a scoring computer, a first mandatory selection criteria corresponding to a first user selection (block 202). For instance, a first user selection may be a selection of a jurisdiction or other mandatory criterion for assignment to a mandatory criteria set. The method may include receiving, by the scoring computer, at least one preferred criteria comprising a criterion and a weight corresponding to a second user selection (block 204). The method may include requesting, by the scoring computer, at least a plurality of target data structures comprising a target identifier and plurality of target criteria from a target data repository (block 206). In various embodiments, the method includes filtering, by the scoring computer, the target data structures to reject target data structures lacking a target criterion from among the plurality of target criteria that corresponds to the first mandatory selection criteria, to generate a first remaining target data structure set (block 208). Finally, the method includes filtering, by the scoring computer, the target data structures to reject target data structures further lacking the target criterion corresponding to at least one preferred criteria to generate a final target data structure set (block 210) and transmitting, by the scoring computer, the final target data structure set to a remote selection device via a network.

Various aspects of the method 200 may be performed by the remote selection device 34 (FIG. 1) rather than the scoring computer 2 (FIG. 1). For instance, the method 200 may include receiving, by the remote selection device, the final target data structure set (block 222). The method 200 may include ranking, by the remote selection device, the target data structures according to a greatest to a least of the weight associated with the criteria (and/or a sum of weights associated with a plurality of criteria for each target data structure) (block 224). The method may include displaying an ordered list corresponding to the ranking of the target data structures on a user interface of the remote selection device (block 226).

In some embodiments of the method, the first mandatory selection criteria is received from the remote selection device and the remote selection device is configured to receive the first user selection via a user interface and transmit the first user selection over the network and to the scoring computer. As mentioned previously, the first mandatory selection criteria may include a selection of a jurisdiction in which tax services are needed. The target data structures each correspond to a certified public accountant providing tax services. In various embodiments, the target criterion comprises an active license in a jurisdiction corresponding to the first mandatory selection criteria.

Moreover, the preferred criteria may be selected from a group consisting of a specific expertise related to tax services, a practice specialization that would be required based upon a tax returns, the software a certified public accountant employs to complete the tax returns, a physical location of the certified public accountant, an availability of the certified public accountant to work remotely, and a criteria that would be useful in determining a fitness of the certified public accountant against a need of a client. The target criteria may include (a) percentage of filing business dedicated to a specialty, (b) years of experience in a specialty, and (c) physical distance from a filer. The weight associated with the criteria may be a value between 0 and 1 inclusive, that sum to 1 for all criteria associated with the target identifier. Finally, in various embodiments, the displaying the ordered list includes displaying a single target data structure corresponding to the greatest of the weight associated with the criteria.

The detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. Furthermore, any reference to singular includes plural embodiments, and any reference to more than one component may include a singular embodiment. Although specific advantages have been enumerated herein, various embodiments may include some, none, or all of the enumerated advantages.

In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. § 112(f) unless the element is expressly recited using the phrase “means for” or “step for”. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Terms and phrases similar to “associate” and/or “associating” may include tagging, flagging, correlating, using a look-up table or any other method or system for indicating or creating a relationship between elements, such as, for example, (i) a mandatory criteria and/or preferred criteria and (ii) a target criteria. Moreover, the associating may occur at any point, in response to any suitable action, event, or period of time. The associating may occur at pre-determined intervals, periodically, randomly, once, more than once, or in response to a suitable request or action. Any of the information may be distributed and/or accessed via a software enabled link, wherein the link may be sent via an email, text, post, social network input, and/or any other method known in the art.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

In various embodiments, software may be stored in a computer program product and loaded into a computer system using a removable storage drive, hard disk drive, or communications interface. The control logic (software), when executed by the processor, causes the processor to perform the functions of various embodiments as described herein. In various embodiments, hardware components may take the form of application specific integrated circuits (ASICs). Implementation of the hardware so as to perform the functions described herein will be apparent to persons skilled in the relevant art(s).

As will be appreciated by one of ordinary skill in the art, the system may be embodied as a customization of an existing system, an add-on product, a processing apparatus executing upgraded software, a stand-alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software, and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY DISC®, optical storage devices, magnetic storage devices, and/or the like.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, an APPLE® iOS operating system, a BLACKBERRY® company's operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

The system and method may be described herein in terms of functional block components, screen shots, optional selections, and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C #, JAVA®, JAVASCRIPT®, JAVASCRIPT® Object Notation (JSON), VBScript, Macromedia COLD FUSION, COBOL, MICROSOFT® company's Active Server Pages, assembly, PERL®, PHP, awk, PYTHON®, Visual Basic, SQL Stored Procedures, PL/SQL, any UNIX® shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript, or the like.

The system and method are described herein with reference to screen shots, block diagrams and flowchart illustrations of methods, apparatus, and computer program products according to various embodiments. It will be understood that each functional block of the block diagrams and the flowchart illustrations, and combinations of functional blocks in the block diagrams and flowchart illustrations, respectively, can be implemented by computer program instructions.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS® applications, webpages, websites, web forms, prompts, etc. Practitioners will appreciate that the illustrated steps described herein may comprise, in any number of configurations, including the use of WINDOWS® applications, webpages, web forms, popup WINDOWS® applications, prompts, and the like. It should be further appreciated that the multiple steps as illustrated and described may be combined into single webpages and/or WINDOWS® applications but have been expanded for the sake of simplicity. In other cases, steps illustrated and described as single process steps may be separated into multiple webpages and/or WINDOWS® applications but have been combined for simplicity.

In various embodiments, the software elements of the system may also be implemented using a JAVASCRIPT® run-time environment configured to execute JAVASCRIPT® code outside of a web browser. For example, the software elements of the system may also be implemented using NODE.JS® components. NODE.JS® programs may implement several modules to handle various core functionalities. For example, a package management module, such as NPM®, may be implemented as an open source library to aid in organizing the installation and management of third-party NODE.JS® programs. NODE.JS® programs may also implement a process manager, such as, for example, Parallel Multithreaded Machine (“PM2”); a resource and performance monitoring tool, such as, for example, Node Application Metrics (“appmetrics”); a library module for building user interfaces, and/or any other suitable and/or desired module.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the internet server. Middleware may be configured to process transactions between the various components of an application server and any number of internal or external systems for any of the purposes disclosed herein. WEBSPHERE® MQ™ (formerly MQSeries) by IBM®, Inc. (Armonk, N.Y.) is an example of a commercially available middleware product. An Enterprise Service Bus (“ESB”) application is another example of middleware.

The computers discussed herein may provide a suitable website or other internet-based graphical user interface which is accessible by users. In one embodiment, MICROSOFT® company's Internet Information Services (IIS), Transaction Server (MTS) service, and an SQL SERVER® database, are used in conjunction with MICROSOFT® operating systems, WINDOWS NT® web server software, SQL SERVER® database, and MICROSOFT® Commerce Server. Additionally, components such as ACCESS® software, SQL SERVER® database, ORACLE® software, SYBASE® software, INFORMIX® software, MYSQL® software, INTERBASE® software, etc., may be used to provide an Active Data Object (ADO) compliant database management system. In one embodiment, the APACHE® web server is used in conjunction with a LINUX® operating system, a MYSQL® database, and PERL®, PHP, Ruby, and/or PYTHON® programming languages.

For the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

In various embodiments, the system and various components may integrate with one or more smart digital assistant technologies. For example, exemplary smart digital assistant technologies may include the ALEXA® system developed by the AMAZON® company, the GOOGLE HOME® system developed by Alphabet, Inc., the HOMEPOD® system of the APPLE® company, and/or similar digital assistant technologies. The ALEXA® system, GOOGLE HOME® system, and HOMEPOD® system, may each provide cloud-based voice activation services that can assist with tasks, entertainment, general information, and more. All the ALEXA devices, such as the AMAZON ECHO®, AMAZON ECHO DOT®, AMAZON TAP®, and AMAZON FIRE® TV, have access to the ALEXA® system. The ALEXA® system, GOOGLE HOME® system, and HOMEPOD® system may receive voice commands via its voice activation technology, activate other functions, control smart devices, and/or gather information. For example, the smart digital assistant technologies may be used to interact with music, emails, texts, phone calls, question answering, home improvement information, smart home communication/activation, games, shopping, making to-do lists, setting alarms, streaming podcasts, playing audiobooks, and providing weather, traffic, and other real time information, such as news. The ALEXA®, GOOGLE HOME®, and HOMEPOD® systems may also allow the user to access information about eligible transaction accounts linked to an online account across all digital assistant-enabled devices.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. As those skilled in the art will appreciate, user computer may include an operating system (e.g., WINDOWS®, UNIX®, LINUX®, SOLARIS®, MACOS®, etc.) as well as various conventional support software and drivers typically associated with computers.

The present system or any part(s) or function(s) thereof may be implemented using hardware, software, or a combination thereof and may be implemented in one or more computer systems or other processing systems. However, the manipulations performed by embodiments may be referred to in terms, such as matching or selecting, which are commonly associated with mental operations performed by a human operator. No such capability of a human operator is necessary, or desirable, in most cases, in any of the operations described herein. Rather, the operations may be machine operations or any of the operations may be conducted or enhanced by artificial intelligence (AI) or machine learning. AI may refer generally to the study of agents (e.g., machines, computer-based systems, etc.) that perceive the world around them, form plans, and make decisions to achieve their goals. Foundations of AI include mathematics, logic, philosophy, probability, linguistics, neuroscience, and decision theory. Many fields fall under the umbrella of AI, such as computer vision, robotics, machine learning, and natural language processing. Useful machines for performing the various embodiments include general purpose digital computers or similar devices.

In various embodiments, the embodiments are directed toward one or more computer systems capable of carrying out the functionalities described herein. The computer system includes one or more processors. The processor is connected to a communication infrastructure (e.g., a communications bus, crossover bar, network, etc.). Various software embodiments are described in terms of this exemplary computer system. After reading this description, it will become apparent to a person skilled in the relevant art(s) how to implement various embodiments using other computer systems and/or architectures. The computer system can include a display interface that forwards graphics, text, and other data from the communication infrastructure (or from a frame buffer not shown) for display on a display unit.

The computer system also includes a main memory, such as random access memory (RAM), and may also include a secondary memory. The secondary memory may include, for example, a hard disk drive, a solid-state drive, and/or a removable storage drive. The removable storage drive reads from and/or writes to a removable storage unit in a well-known manner. As will be appreciated, the removable storage unit includes a computer usable storage medium having stored therein computer software and/or data.

In various embodiments, secondary memory may include other similar devices for allowing computer programs or other instructions to be loaded into a computer system. Such devices may include, for example, a removable storage unit and an interface. Examples of such may include a program cartridge and cartridge interface (such as that found in video game devices), a removable memory chip (such as an erasable programmable read only memory (EPROM), programmable read only memory (PROM)) and associated socket, or other removable storage units and interfaces, which allow software and data to be transferred from the removable storage unit to a computer system.

The terms “computer program medium,” “computer usable medium,” and “computer readable medium” are used to generally refer to media such as removable storage drive and a hard disk installed in hard disk drive. These computer program products provide software to a computer system.

The computer system may also include a communications interface. A communications interface allows software and data to be transferred between the computer system and external devices. Examples of such a communications interface may include a modem, a network interface (such as an Ethernet card), a communications port, etc. Software and data transferred via the communications interface are in the form of signals which may be electronic, electromagnetic, optical, or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16-bit integers.

The firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, ProX-Y based, access control lists, and Packet Filtering among others. Firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the internet. A firewall may be integrated as software within an internet server or any other application server components, reside within another computing device, or take the form of a standalone hardware component.

Any databases discussed herein may include relational, hierarchical, graphical, blockchain, object-oriented structure, and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2® by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MYSQL® by MySQL AB (Uppsala, Sweden), MONGODB®, Redis, APACHE CASSANDRA®, HBASE® by APACHE®, MapR-DB by the MAPR® corporation, or any other suitable database product. Moreover, any database may be organized in any suitable manner, for example, as data tables or lookup tables. Each record may be a single file, a series of files, a linked series of data fields, or any other data structure.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); data stored as Binary Large Object (BLOB); data stored as ungrouped data elements encoded using ISO/IEC 7816-6 data elements; data stored as ungrouped data elements encoded using ISO/IEC Abstract Syntax Notation (ASN.1) as in ISO/IEC 8824 and 8825; other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with the system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header,” “header,” “trailer,” or “status,” herein, and may comprise an indication of the status of the data set or may include an identifier correlated to a specific issuer or owner of the data. In one example, the first three bytes of each data set BLOB may be configured or configurable to indicate the status of that particular data set, e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user, or the like. Furthermore, the security information may restrict/permit only certain actions, such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer, may be received by a standalone interaction device configured to add, delete, modify, or augment the data in accordance with the header or trailer. As such, in one embodiment, the header or trailer is not stored on the transaction device along with the associated issuer-owned data, but instead the appropriate action may be taken by providing to the user, at the standalone device, the appropriate option for the action to be taken. The system may contemplate a data storage arrangement wherein the header or trailer, or header or trailer history, of the data is stored on the system, device or transaction instrument in relation to the appropriate data.

One skilled in the art will also appreciate that, for security reasons, any databases, systems, devices, servers, or other components of the system may consist of any combination thereof at a single location or at multiple locations, wherein each database or system includes any of various suitable security features, such as firewalls, access codes, encryption, decryption, compression, decompression, and/or the like.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The data may be big data that is processed by a distributed computing cluster. The distributed computing cluster may be, for example, a HADOOP® software cluster configured to process and store big data sets with some of nodes comprising a distributed storage system and some of nodes comprising a distributed processing system. In that regard, distributed computing cluster may be configured to support a HADOOP® software distributed file system (HDFS) as specified by the Apache Software Foundation at www.hadoop.apache.org/docs.

As used herein, the term “network” includes any cloud, cloud computing system, or electronic communications system or method which incorporates hardware and/or software components. Communication among the parties may be accomplished through any suitable communication channels, such as, for example, a telephone network, an extranet, an intranet, internet, point of interaction device (point of sale device, personal digital assistant (e.g., an IPHONE® device, a BLACKBERRY® device), cellular phone, kiosk, etc.), online communications, satellite communications, off-line communications, wireless communications, transponder communications, local area network (LAN), wide area network (WAN), virtual private network (VPN), networked or linked devices, keyboard, mouse, and/or any suitable communication or data input modality. Moreover, although the system is frequently described herein as being implemented with TCP/IP communications protocols, the system may also be implemented using IPX, APPLETALK® program, IP-6, NetBIOS, OSI, any tunneling protocol (e.g., IPsec, SSH, etc.), or any number of existing or future protocols. If the network is in the nature of a public network, such as the internet, it may be advantageous to presume the network to be insecure and open to eavesdroppers. Specific information related to the protocols, standards, and application software utilized in connection with the internet is generally known to those skilled in the art and, as such, need not be detailed herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

As used herein, “transmit” may include sending electronic data from one system component to another over a network connection. Additionally, as used herein, “data” may include encompassing information such as commands, queries, files, data for storage, and the like in digital or any other form.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus-based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a HYPERLEDGER Fabric 1.0 based platform, the duration is driven by the specific consensus algorithm that is chosen and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network.

The particular blockchain implementation described herein provides improvements over conventional technology by using a decentralized database and improved processing environments. In particular, the blockchain implementation improves computer performance by, for example, leveraging decentralized resources (e.g., lower latency). The distributed computational resources improves computer performance by, for example, reducing processing times. Furthermore, the distributed computational resources improves computer performance by improving security using, for example, cryptographic protocols.

Any communication, transmission, and/or channel discussed herein may include any system or method for delivering content (e.g., data, information, metadata, etc.), and/or the content itself. The content may be presented in any form or medium, and in various embodiments, the content may be delivered electronically and/or capable of being presented electronically. For example, a channel may comprise a website, mobile application, or device (e.g., FACEBOOK®, YOUTUBE®, PANDORA®, APPLE TV®, MICROSOFT® XBOX®, ROKU®, AMAZON FIRE®, GOOGLE CHROMECAST™, SONY® PLAYSTATION®, NINTENDO® SWITCH®, etc.) a uniform resource locator (“URL”), a document (e.g., a MICROSOFT® Word or EXCEL™, an ADOBE® Portable Document Format (PDF) document, etc.), an “ebook,” an “emagazine,” an application or microapplication (as described herein), an short message service (SMS) or other type of text message, an email, a FACEBOOK® message, a TWITTER® tweet, multimedia messaging services (MMS), and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network, and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, LINKEDIN®, INSTAGRAM®, PINTEREST®, TUMBLR®, REDDIT, SNAPCHAT®, WHATSAPP®, FLICKR®, VK®, QZONE®, WECHAT, and the like. Examples of affiliate or partner websites include AMERICAN EXPRESS®, GROUPON®, LIVINGSOCIAL, and the like. Moreover, examples of mobile device communications include texting, email, and mobile applications for smartphones.

We claim:

1. A method, comprising:
receiving, by a scoring computer, a first mandatory selection criteria corresponding to a first user selection;
receiving, by the scoring computer, a preferred criteria comprising a criterion and a weight corresponding to a second user selection,
requesting, by the scoring computer, a plurality of target data structures comprising a target identifier and plurality of target criteria from a target data repository;
filtering, by the scoring computer, the target data structures to reject target data structures lacking a target criterion from among the plurality of target criteria that corresponds to the first mandatory selection criteria, to generate a first remaining target data structure set;
filtering, by the scoring computer, the target data structures of the first remaining target data structure set to reject target data structures further lacking the target criterion corresponding to the preferred criteria to generate a final target data structure set; and
transmitting, by the scoring computer, the final target data structure set to a remote selection device via a network.

2. The method according to claim 1, wherein the remote selection device:
receives the final target data structure set;
ranks the target data structures according to a greatest to a least of the weight associated with the criteria; and
displays an ordered list corresponding to the ranking of the target data structures on a user interface of the remote selection device.

3. The method according to claim 1, wherein the remote selection device:
receives the final target data structure set;
ranks the target data structures according to a greatest to a least of a sum of weights associated with a plurality of criteria for each target data structure; and
displays an ordered list corresponding to the ranking of the target data structures.

4. The method according to claim 2, wherein the remote selection device:
receives the first mandatory selection criteria;
receives the first user selection via a user interface;
transmits the first user selection over the network and to the scoring computer.

5. The method according to claim 1,
wherein the first mandatory selection criteria comprises a selection of a jurisdiction in which tax services are needed, and
wherein the target data structures each correspond to a certified public accountant providing tax services.

6. The method according to claim 5, wherein the target criterion comprises an active license in a jurisdiction corresponding to the first mandatory selection criteria.

7. The method according to claim 5, wherein the preferred criteria includes at least one of a specific expertise related to tax services, a practice specialization that would be required based upon a tax returns, a software a certified public accountant employs to complete the tax returns, a physical location of the certified public accountant, an availability of the certified public accountant to work remotely, or a criteria that would be useful in determining a fitness of the certified public accountant against a need of a client.

8. The method according to claim 1, wherein the target criteria includes (a) percentage of filing business dedicated to a specialty, (b) years of experience in a specialty, and (c) physical distance from a filer.

9. The method according to claim 2, wherein the weight associated with the criteria is a value between 0 and 1 inclusive, that sums to 1 for all criteria associated with the target identifier.

10. The method of claim 2, wherein the displaying the ordered list comprises displaying a single target data structure corresponding to the greatest of the weight associated with the criteria.

11. A scoring computer comprising:
a processor; and
a tangible, non-transitory memory configured to communicate with the processor,
the tangible, non-transitory memory having instructions stored thereon that, in response to execution by the processor, cause the processor to perform operations comprising:
receiving, by the scoring computer, a first mandatory selection criteria corresponding to a first user selection;
receiving, by the scoring computer, a preferred criteria comprising a criterion and a weight corresponding to a second user selection,
requesting, by the scoring computer, a plurality of target data structures comprising a target identifier and plurality of target criteria from a target data repository;
filtering, by the scoring computer, the target data structures to reject target data structures lacking a target criterion from among the plurality of target criteria that corresponds to the first mandatory selection criteria, to generate a first remaining target data structure set;
filtering, by the scoring computer, the target data structures of the first remaining target data structure set to reject target data structures further lacking the target criterion corresponding to the preferred criteria to generate a final target data structure set; and
transmitting, by the scoring computer, the final target data structure set to a remote selection device via a network.

12. The system according to claim 11, wherein the remote selection device:
receives the final target data structure set;
ranks the target data structures according to a greatest to a least of the weight associated with the criteria; and
displays an ordered list corresponding to the ranking of the target data structures on a user interface of the remote selection device.

13. The system according to claim 11, wherein the remote selection device:
receives the final target data structure set;
ranks the target data structures according to a greatest to a least of a sum of weights associated with a plurality of criteria for each target data structure; and
displays an ordered list corresponding to the ranking of the target data structures.

14. The system according to claim 12, wherein the remote selection device:
receives the first mandatory selection criteria;
receives the first user selection via a user interface;
transmits the first user selection over the network and to the scoring computer.

15. The system according to claim 11,
wherein the first mandatory selection criteria comprises a selection of a jurisdiction in which tax services are needed, and
wherein the target data structures each correspond to a certified public accountant providing tax services.

16. The system according to claim 15, wherein the target criterion comprises an active license in a jurisdiction corresponding to the first mandatory selection criteria.

17. The system according to claim 15, wherein the preferred criteria includes at least one of a specific expertise related to tax services, a practice specialization that would be required based upon a tax returns, a software a certified public accountant employs to complete the tax returns, a physical location of the certified public accountant, an availability of the certified public accountant to work remotely, or a criteria that would be useful in determining a fitness of the certified public accountant against a need of a client.

18. The system according to claim 11, wherein the target criteria includes (a) percentage of filing business dedicated to a specialty, (b) years of experience in a specialty, and (c) physical distance from a filer.

19. The system according to claim 12, wherein the weight associated with the criteria is a value between 0 and 1 inclusive, that sums to 1 for all criteria associated with the target identifier.

20. An article of manufacture including a non-transitory, tangible computer readable storage medium having instructions stored thereon that, in response to execution by a scoring computer, cause the scoring computer to perform operations comprising:
receiving, by the scoring computer, a first mandatory selection criteria corresponding to a first user selection;
receiving, by the scoring computer, a preferred criteria comprising a criterion and a weight corresponding to a second user selection,
requesting, by the scoring computer, a plurality of target data structures comprising a target identifier and plurality of target criteria from a target data repository;
filtering, by the scoring computer, the target data structures to reject target data structures lacking a target criterion from among the plurality of target criteria that corresponds to the first mandatory selection criteria, to generate a first remaining target data structure set;
filtering, by the scoring computer, the target data structures of the first remaining target data structure set to reject target data structures further lacking the target criterion corresponding to the preferred criteria to generate a final target data structure set; and
transmitting, by the scoring computer, the final target data structure set to a remote selection device via a network.
